(19) United States
(12) Patent Application Publication
(10) Pub. No.: US 2010/0193275 A1
(43) Pub. Date: Aug. 5, 2010

(54) MOTORCYCLE

(75) Inventors: MICHAEL M. SONG, MAPLE GROVE, MN (US); GREGORY C. BREW, MINNETONKA, MN (US); THOMAS CHRISTOPHER HANEGRAAF, ELK RIVER, MN (US)

Correspondence Address: Baker & Daniels LLP-Polaris, 300 N. Meridian Street, Suite 2700, Indianapolis, IN, 46204, US

(73) Assignee: POLARIS INDUSTRIES INC., MEDINA, MN (US)

(21) Appl. No.: 12/686,181

(22) Filed: Jan. 12, 2010

Related U.S. Application Data
(60) Provisional application No. 61/204,865, filed on Jan. 12, 2009.

(51) Int. Cl. B62K 11/04; B62K 21/04

(52) U.S. Cl. 180/219; 280/270

(57) ABSTRACT

A motorcycle is shown comprising a frame comprised of plural cast components coupled together. The frame is comprised of an upper one-piece frame portion having an integrated air tank and an integrated fuel tank therein. The integrated air tank is defined by a forward portion of the upper main frame portion, and a forward open face of the integrated air tank defines an air intake. The fuel tank is defined by a wall separating the upper one-piece frame portion into the two sections. Upper and lower steering post sockets are also integrated into the frame, rearward of the air intake and a steering post extends through the air intake portion of the frame.

### RELATED APPLICATIONS

This application is a non-provisional of U.S. Provisional Application Ser. No. 61/204,865, filed Jun. 12, 2009, docket PLR-01-23771.02P, the disclosure of which is expressly incorporated by reference herein.

### BACKGROUND

The subject disclosure relates to a motorcycle.

Typically, a motorcycle utilizes a tubular frame that cradles an engine and attaches to a front and a rear suspension. The tubes of the tubular frame may be forged and then welded or fastened together. Depending on the tubular frame structure, the frame may be relatively less rigid thus increasing the propensity of the frame to flex. Increased flexing of the frame may enhance vibration and noise. Welding and mechanical fastening of the tubular frame members may increase point-to-point dimensional tolerances. Moreover, for each motorcycle size and or style, a different frame or frame size is required.

Typically, a plastic and independent air box couples to the engine. The air box filters and directs air into the intake of the engine and is positioned between the tubular frame and the engine. It will be appreciated that one way to increase the structural rigidity of the tubular frame is to enlarge the frame by, for example, increasing the diameter of the tubing. It will also be appreciated that one way to increase airflow through the air box is to increase the volume of the air box. With the above in mind, both the tubular frame and the air box compete for an allocation of space and gross weight on the motorcycle.

Moreover, a separate steel fuel tank normally sits on top of the frame, forward of the seat. This places a large, as well as variable, amount of mass at a large vertical distance from the ground, which in turn has an effect on the vertical component of the center of gravity. As the center of gravity is raised, the motorcycle becomes more unstable. From a cosmetic standpoint, this also exposes large hoses on the outside of the motorcycle causing exposure to damage as well as detracting from the look of the motorcycle.

### SUMMARY

The objects have been accomplished by providing a motorcycle comprising front and rear tires; an engine; and a frame comprising plural cast components coupled together, which encompass the engine from at least the top and bottom thereof.

In another embodiment, a motorcycle comprises front and rear tires; an engine; and an upper one-piece frame portion having an integrated air tank and an integrated fuel tank therein.

In still another embodiment, a motorcycle comprises a frame comprising an upper main frame portion; an integrated air tank defined by a forward portion of the upper main frame portion, where a forward open face of the integrated air tank defines an air intake; upper and lower steering post sockets integrated into the frame, rearward of the air intake; a steering post extending through the air intake portion of the frame and positioned in the steering post sockets; and a steering clamp assembly.

In yet another embodiment, a front steering mechanism is provided for a motorcycle, comprising an upper clamp member having a center aperture for receiving a steering post, and apertures on either side of the center aperture for receiving forks; a lower clamp member having a center aperture for receiving the steering post, and apertures on either side of the center aperture for receiving forks; a top cap receivable over the upper clamp member, the upper clamp member and the top cap being profiled for receiving a handle bar therethrough.

An embodiment will now be described by way of reference to the following drawings.

### BRIEF DESCRIPTION OF THE DRAWINGS

FIG. 1 is a perspective view of the motorcycle of the subject disclosure;

FIG. 2 is an underside perspective view of the motorcycle of FIG. 1;

FIG. 3 is a left side plan view of the motorcycle of FIGS. 1 and 2;

FIG. 4 is a longitudinal cross-section of the motorcycle of FIGS. 1-3 less the power train;

FIG. 5 is an exploded view of the motorcycle frame;

FIG. 6 is a perspective view of the upper main frame portion;

FIG. 7 is a left side plan view of the upper main frame portion of FIG. 6;

FIG. 8 is an underside perspective view of the upper main frame portion of FIG. 6;

FIG. 9 is a cross-sectional view through lines 9-9 of FIG. 7;

FIG. 10 is a sectional view through lines 10-10 of FIG. 7;

FIG. 11 is a cross-sectional view through lines 11-11 of FIG. 10;

FIGS. 12 and 13 show perspective views of the battery box;

FIGS. 14 and 15 show perspective views of the hard tails;

FIG. 16 is a perspective view of the chin fairing;

FIG. 17 shows a perspective view of the steering assembly;

FIG. 18 is an exploded view of the steering assembly of FIG. 16;

FIGS. 19A and 19B show perspective views of the top triple clamp;

FIGS. 20A and 20B show perspective views of the bottom triple clamp;

FIGS. 21A and 21B show perspective views of the upper cap;

FIG. 22 shows a perspective view of the assembly of the frame portion;

FIG. 23 shows an assembly of a portion of the frame portion with the engine; and

FIG. 24 shows a perspective view of an exemplary fuel pump for internal mounting within the integrated fuel tank.

### DETAILED DESCRIPTION

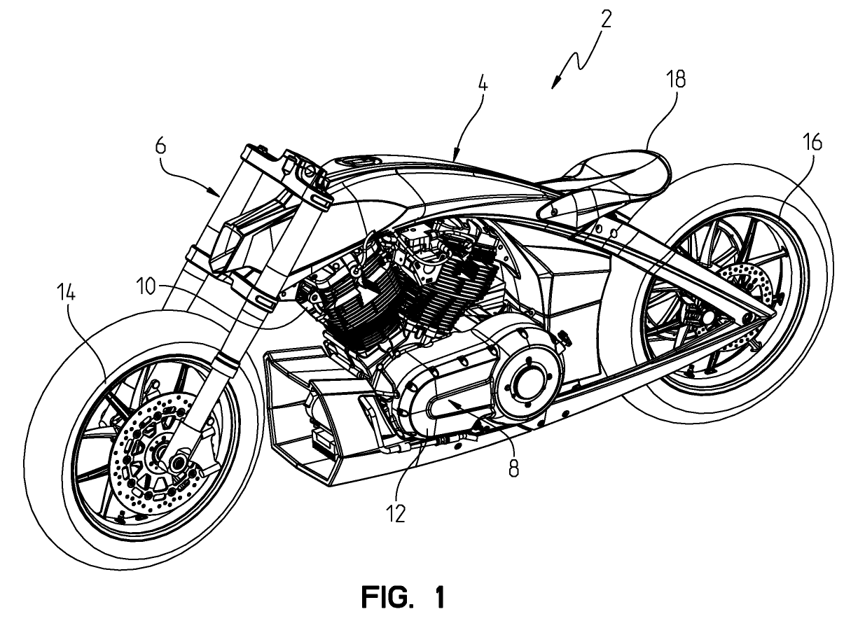

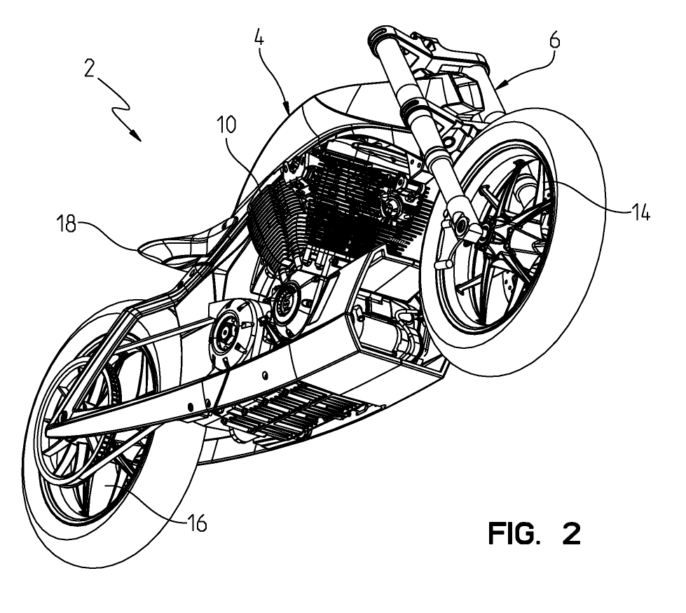

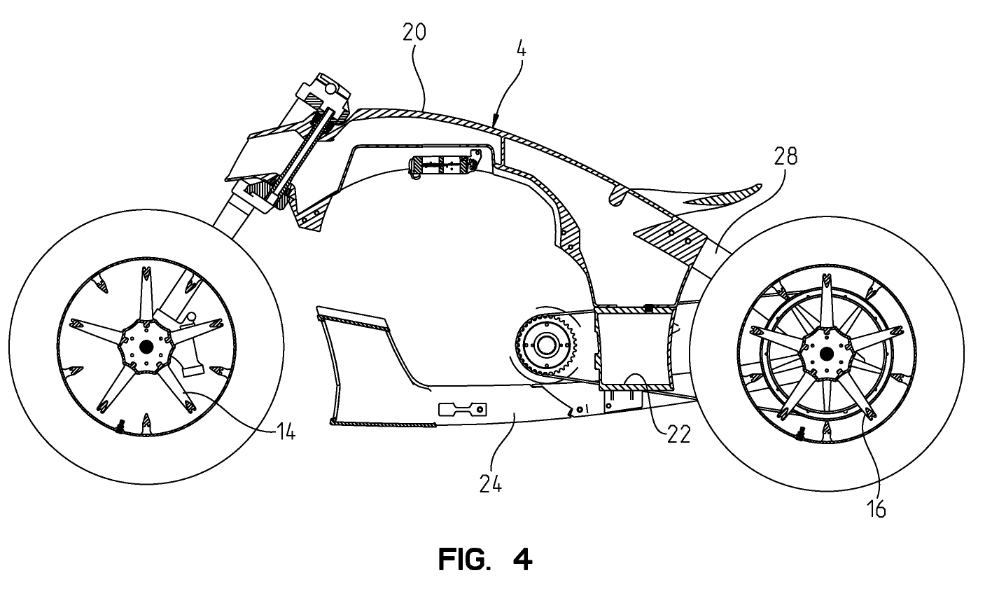

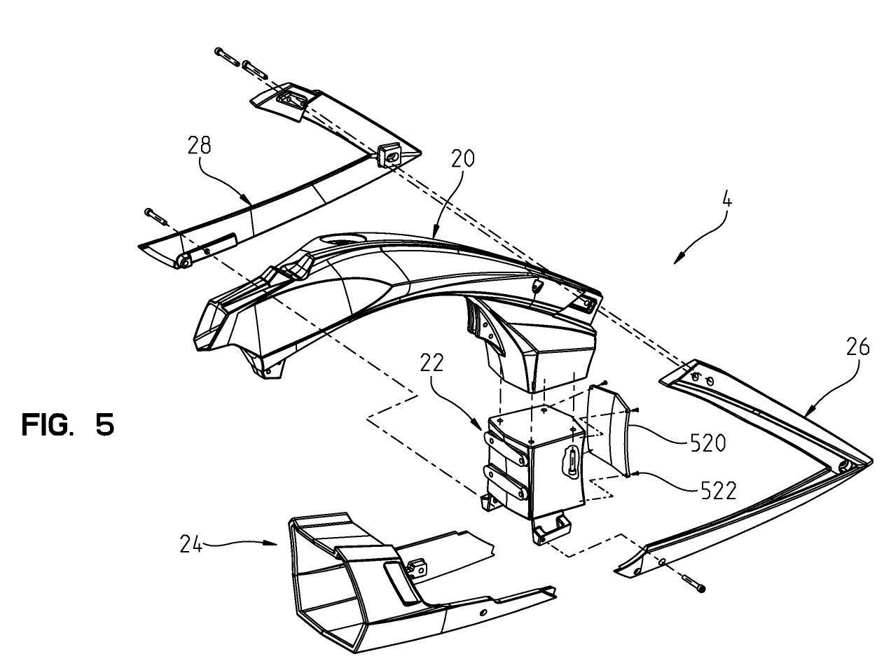

With reference first to FIGS. 1-3, a motorcycle is shown at 2 having a frame 4, steering assembly 6, power train 8 comprised of an engine 10 and a transmission 12, front and rear wheels 14, 16 and seat 18. With reference to FIGS. 4 and 5, frame 4 is comprised of an upper main frame portion 20, a lower rear frame portion or battery box 22, a lower frame portion or chin fairing 24 and frame wheel attachment portions or hard tails 26, 28.

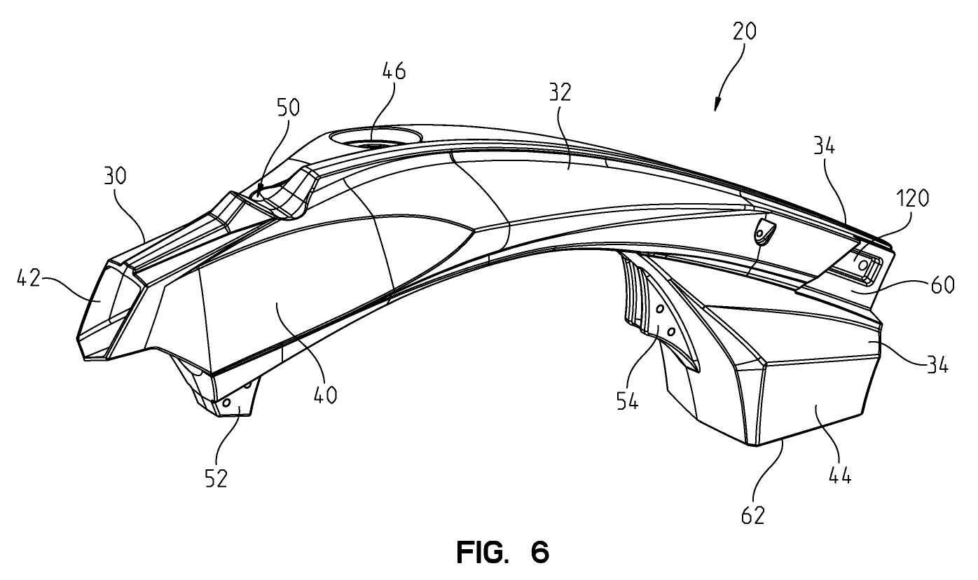

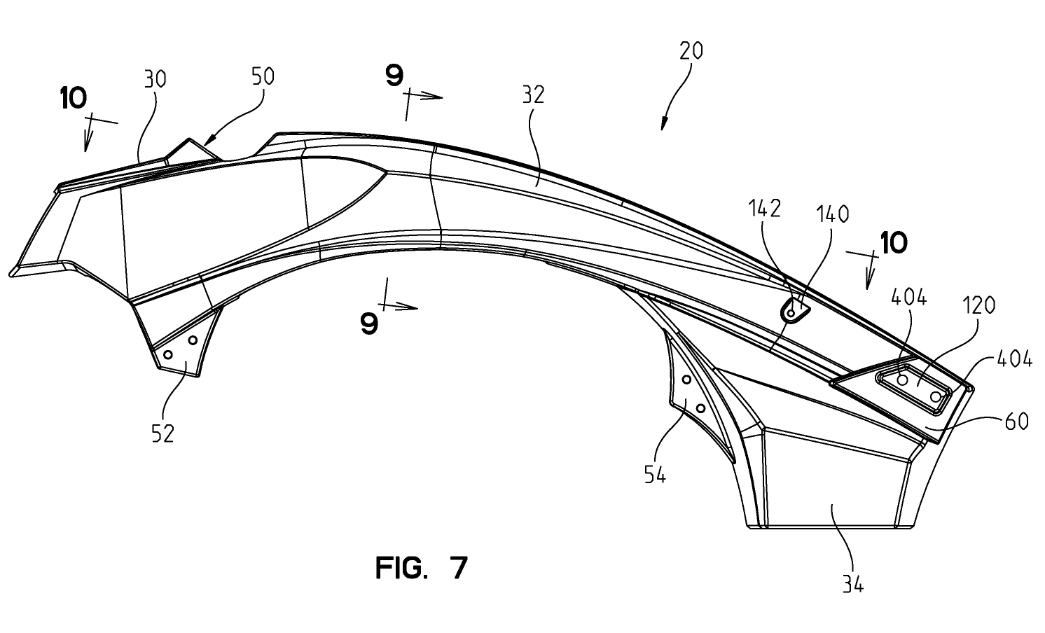

With reference now to FIGS. 6-11, the upper main frame portion 20 will be described in greater detail. As shown best in FIGS. 6 and 7, upper main frame portion 20 is comprised of a one piece integrated member having a front section 30, mid section 32 and a rear section 34. As described herein, upper main frame portion 20 is a one piece cast aluminum member which has an integrated air box 40 having an air intake at 42, an integrated fuel tank at 44 including a fuel filler section at 46, a steering post attachment section at 50, engine mounting sections 52, 54, a hard tail mounting section at 60, and a battery box mounting section at 62.

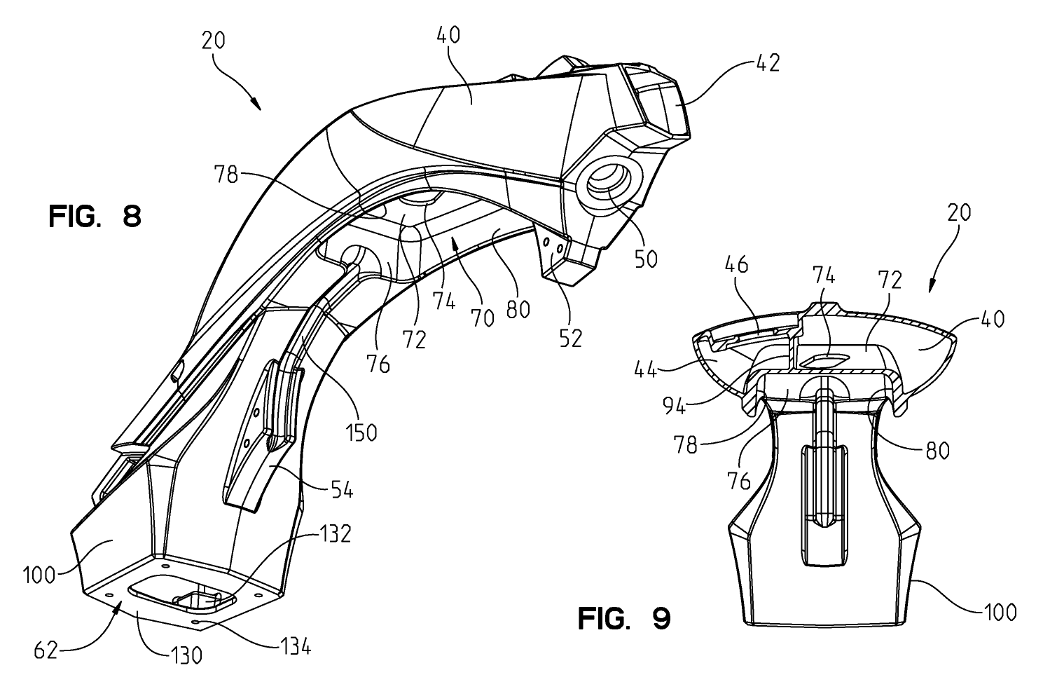

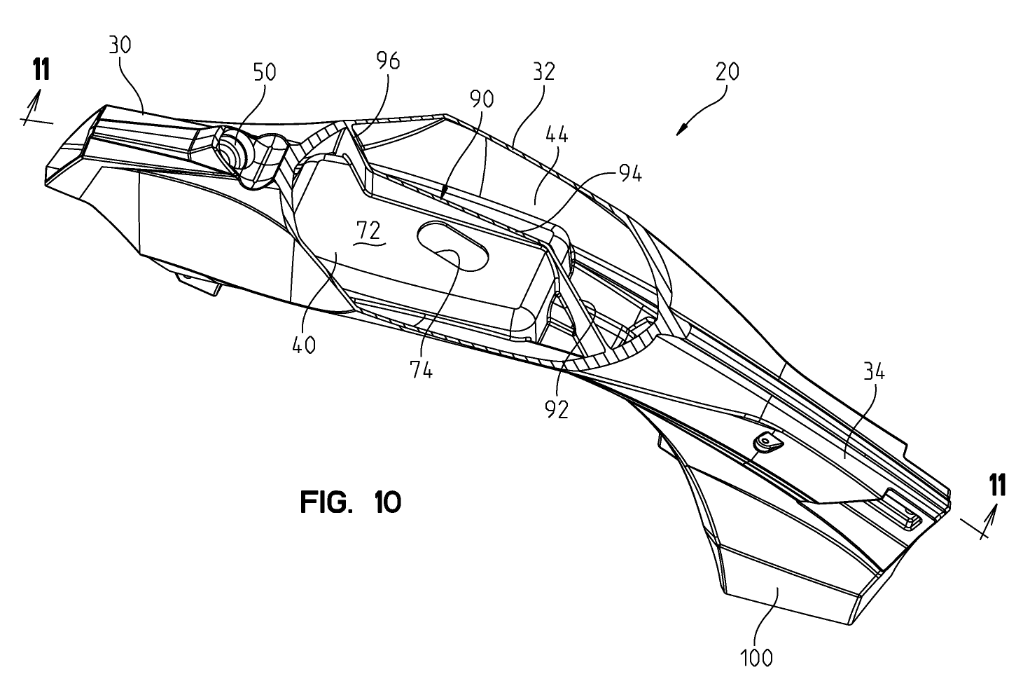

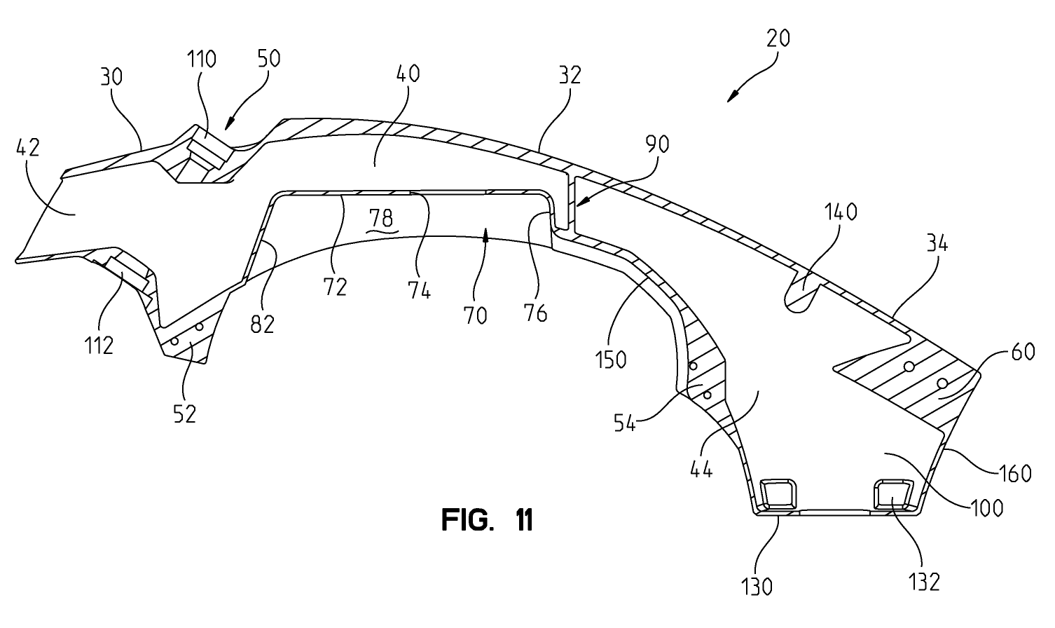

With reference now to FIGS. 8-11, the integrated air tank 40 and fuel tank 44 will be described in greater detail. As shown in FIGS. 8 and 9, a lower cavity 70 is defined beneath the air tank 40 and is comprised of a top wall 72 having an opening at 74, a rear wall 76, side walls 78, 80 and a front wall 82. As best shown in FIGS. 10 and 11, opening 74 communicates with integrated air box 40 as described herein. Integrated air box 40 is defined within the casting by a wall 90 which is comprised of a rear angled wall portion 92 (FIG. 10) and by a long, exterior wall portion 94 and a front wall portion 96 (FIGS. 9 and 10). Thus it should be appreciated that airflow may enter air inlet 42 and fluidly communicate through air box 40 to opening 74 while remaining separate from integrated fuel tank 44.

With reference to FIGS. 9 and 10, integrated fuel tank 44 is shown extending towards the front 30 of upper main frame portion 20 and having a side to side separation with air tank by way of wall portion 94, and a front to back separation with air tank 40 by a wall portions 92, 96. As shown best in FIGS. 6 and 9, the fuel filler section 46 is disposed in the laterally forward portion of the fuel tank 44, but given the general arcuate shape of the upper main frame portion 20, it should be appreciated that fuel dispensed through the filler section 46 would flow rearwardly into the fuel tank 44. It should also be appreciated from a review of FIGS. 8-11 that fuel tank 44 includes an enlarged volume portion 100 which would house a substantial percentage of the overall volume of fuel in tank 44. It should also be appreciated that the fuel tank 44 would be lined with an inorganic coating, as is known in the art. The tank is prepared by plugging all of the holes, and the coating is measured and poured into the tank. The coating is stirred around to ensure full coverage to all of the surfaces. Other areas, such as around the filler cap may require an extra amount of the coating spray.

As best shown in FIGS. 10 and 11, upper main frame portion 20 also includes a plurality of integrated mounting members. Front end 30 includes steering post attachment section 50 comprised of an upper steering post socket 110 and a lower steering post socket 112 for receiving a steering post and suitable bearings. As mentioned before, integrated engine mounting sections 52, 54 extend from an underside of the upper main frame portion 20 as best shown in FIGS. 8 and 11. As best shown in FIGS. 6 and 7, frame rear section 34, and more particularly hard tail mounting section 60 has a recessed section 120 as described herein. As also shown best in FIGS. 8 and 11, enlarged volume portion 100 is defined by a lower face 130 having integral bosses 132 and threaded apertures 134 extending into the bosses 132 as described herein. Rear section 34 of main frame portion 20 further includes a mounting boss 140 having a threaded aperture 142 as best shown in FIGS. 7 and 11. Finally, and with respect to FIGS. 8 and 11, the under arcuate surface of the main frame portion includes a recessed groove 150 extending from cavity 70 downwardly and rearwardly, through rear engine mount section 54. Finally and with respect to FIG. 11, rear face of upper main frame portion 20 includes an arcuate surface 160 as further described herein.

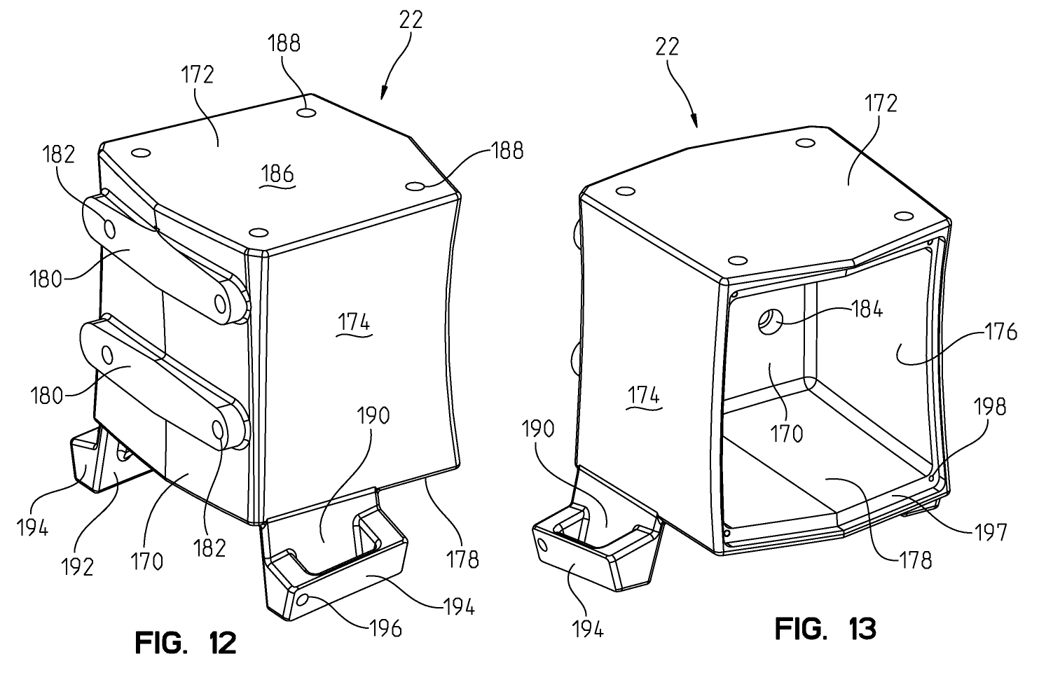

With respect now to FIGS. 12 and 13, battery box 22 is generally defined by a front wall 170, top wall 172, side walls 174, 176 and a lower wall 178. Front wall 170 includes mounting bosses at 180 with apertures 182 leading to internal counterbores 184. Top wall 172 includes a top planar mounting surface 186 having a plurality of apertures 188 extending therethrough, with access from the inside of battery box 22. Side walls 174, 176 include mounting extensions 190, 192 having mounting bosses 194 having threaded apertures at 196. Finally, and as best shown in FIG. 13, battery box 22 includes a recessed mounting surface 197 having threaded apertures 198 at the corners thereof.

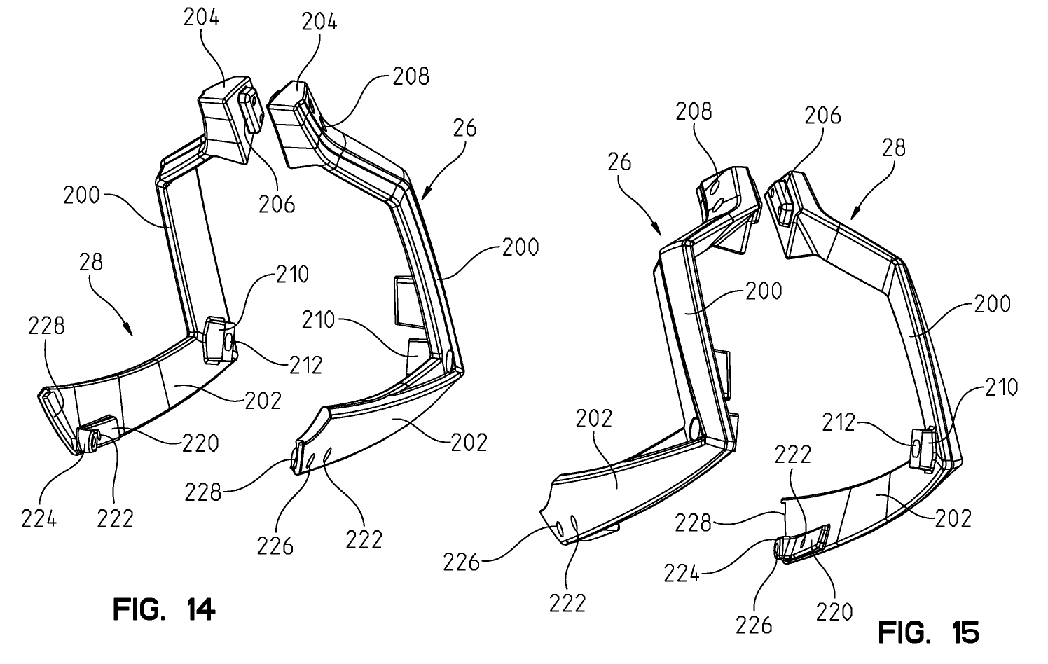

With respect now to FIGS. 14 and 15, hard tails 26, 28 will be described in greater detail. As shown, each of the hard tails is a generally angular shaped member having upper arms 200 and lower arms 202. The free end of arm 202 includes an upper mounting boss portion 204 which is similarly configured as mounting section 60 (FIG. 7) including a mounting protrusion 206 profiled for receipt in recessed section 120 and further comprising mounting through holes at 208. Mounting standoffs 210 are positioned at the intersection of arms 200, 202 and include mounting through holes 212 for receipt of an axle as described herein. A front end of lower arms 202 include mounting bosses 220 having apertures 222, and standoffs 224 having apertures at 226. The forward free ends of arms 202 include recessed sections at 228.

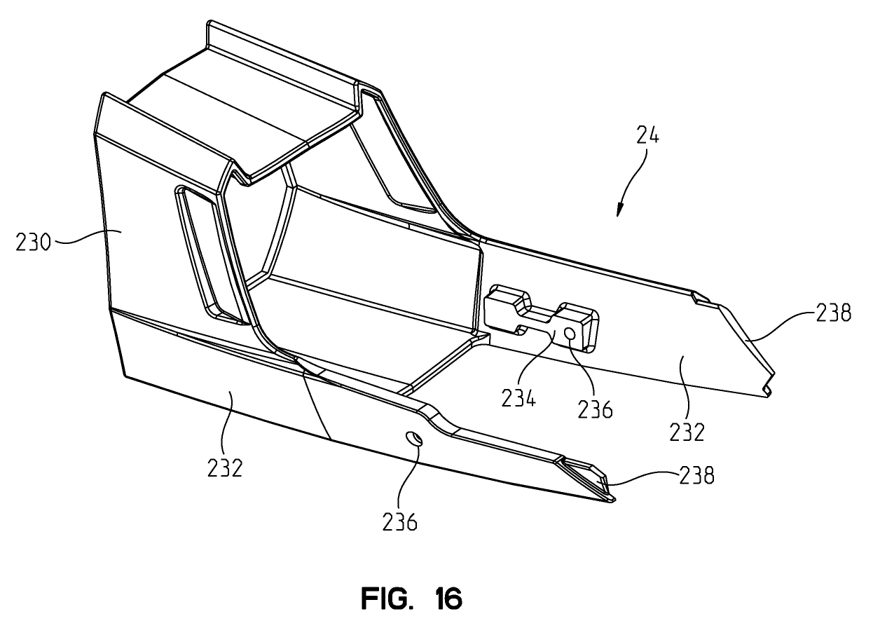

With reference now to FIG. 16, chin fairing 24 is shown in greater detail. Chin fairing 24 includes a front cowl portion 230 having arms 232 attached thereto. Each arm includes a mounting boss 234 where one of the bosses includes an aperture 236.

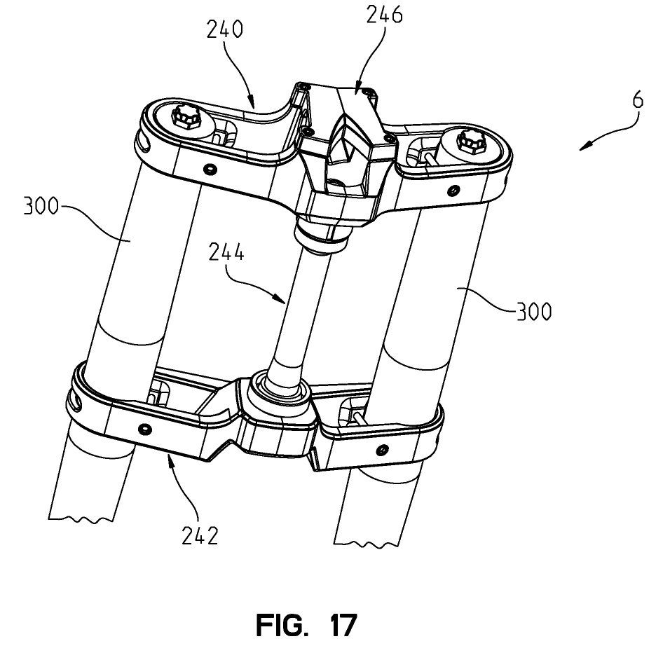

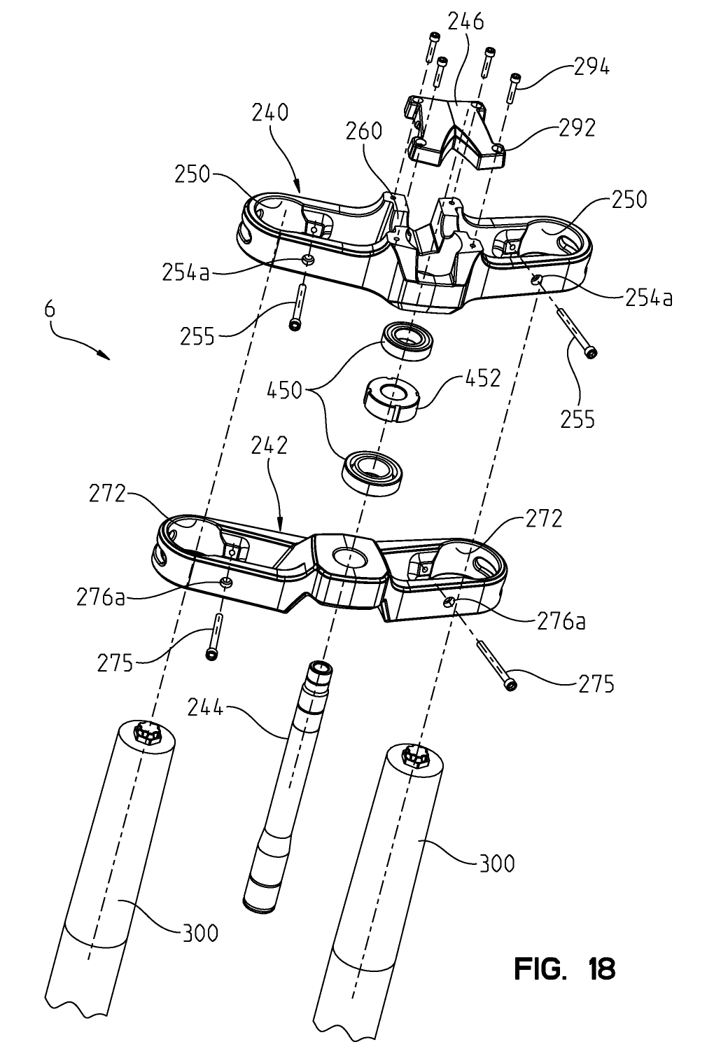

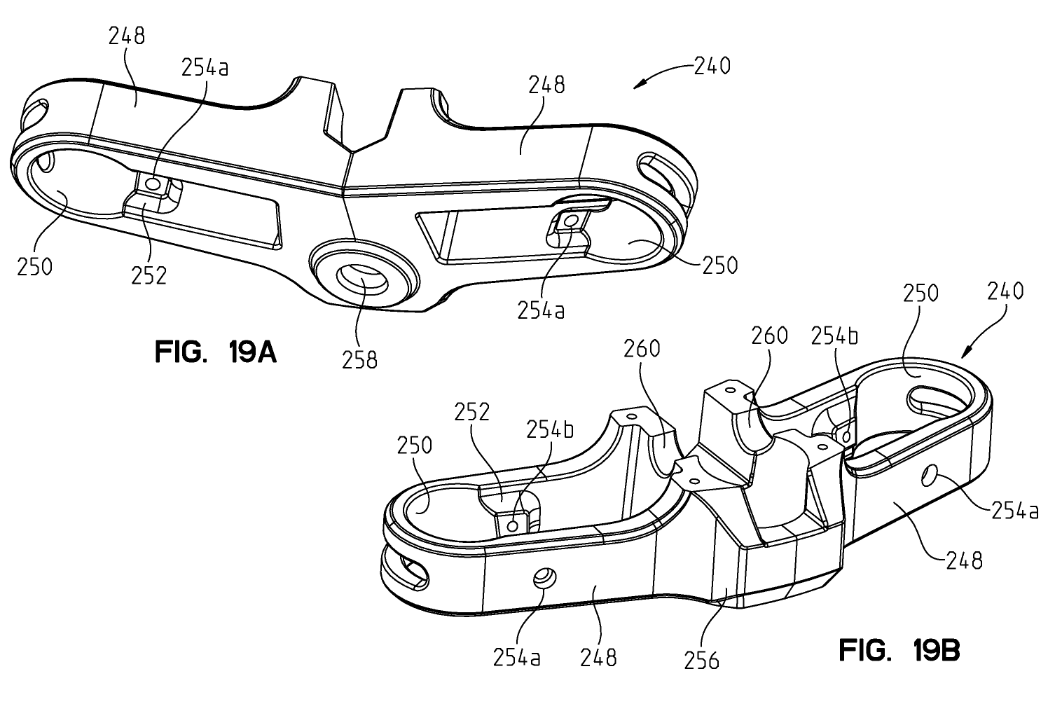

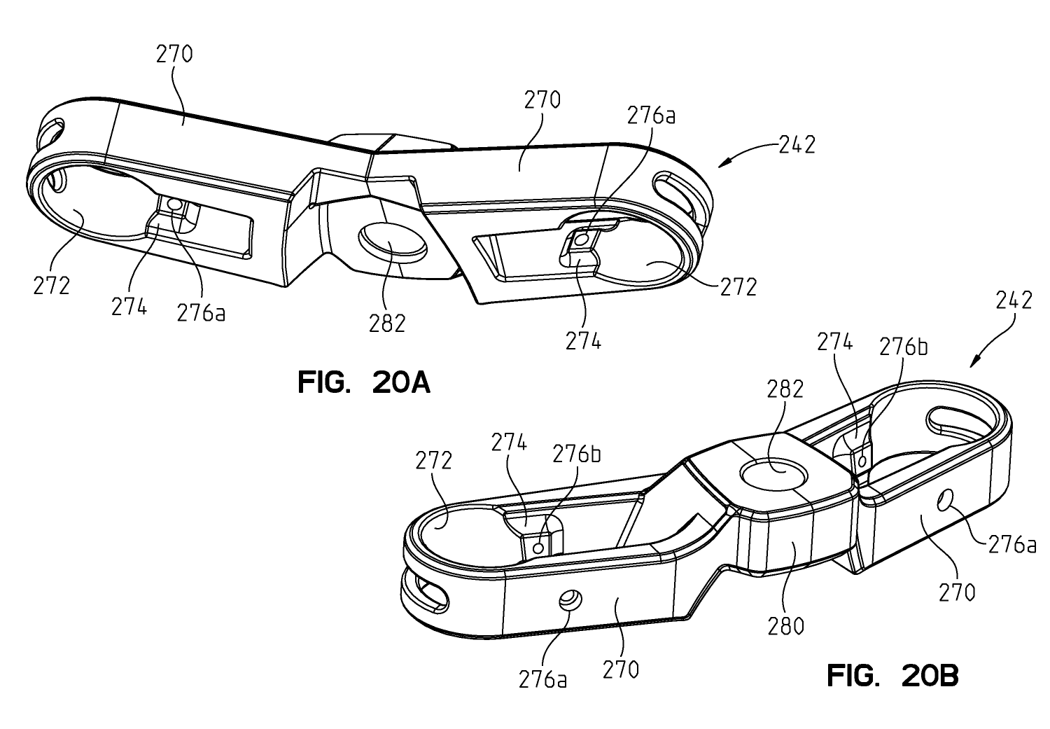

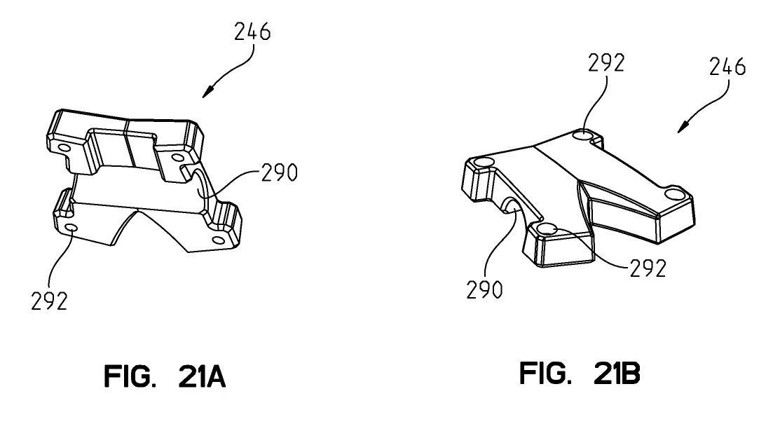

With reference now to FIGS. 17-21, steering assembly 6 is shown in greater detail, and is generally comprised of an upper triple clamp 240, a lower triple clamp 242, a steering post 244, and a top cap 246. As best shown in FIGS. 18, 19A and 19B, top triple clamp 240 includes arms 248 forming circular openings 250. Bosses 252 are positioned adjacent to circular openings 250. Opposed clamping apertures are provided by apertures 254a and threaded apertures 254b. A central section 256 of upper triple clamp 240 includes an aperture 258 to receive steering post 244 and further comprises a U-shaped recess 260 profiled to receive a handlebar as described herein. With respect to FIGS. 18, 20A and 20B, lower triple clamp is similar to upper triple clamp including arms 270 having circular openings at 272 with bosses 274 positioned adjacent to circular openings, having opposed clamping apertures defined at 276a and 276b. A central section 280 includes an aperture 282 for receiving steering post 244. As best shown in FIGS. 21A and 21B, top cap 246 includes a U-shaped recess 290 positioned in a complementary manner to U-shaped recess 260, and includes apertures 292 for receipt of fasteners therethrough.

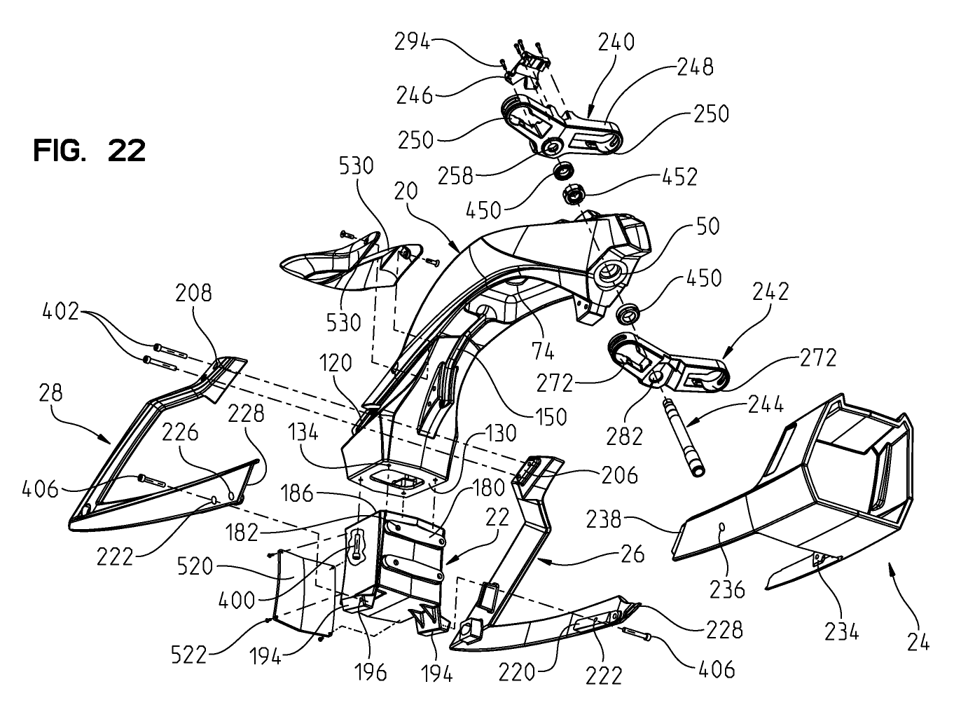

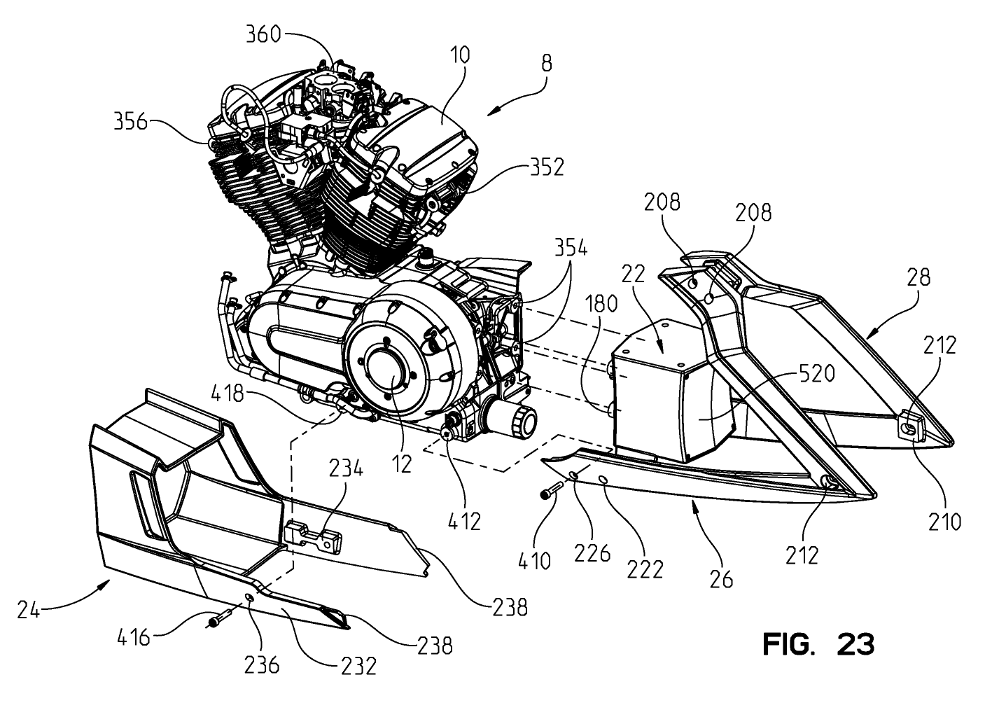

With reference now to FIGS. 22 and 23, the assembly of the motorcycle as described above will generally be discussed. With reference first to FIG. 22, battery box 22 is first positioned with the planar mounting surface 186 against the lower face 130 of the upper main frame portion 20. Fasteners 400 may be received through apertures 188 (FIG. 12) and received into threaded engagement with threaded apertures 134, attaching the battery box 22 to the lower portion of the upper main frame portion 20. Hard tails 26 and 28 may thereafter be positioned against the combination of the upper main frame portion 20 and battery box 22 such that protrusions 206 are received within the recessed sections 120 and fasteners 402 may be received through apertures 208 into threaded engagement with threaded apertures 404 (see FIG. 7). At the same time this positions bosses 220 against bosses 194 of the battery box whereby apertures 222 are aligned with threaded apertures 196. Fasteners 406 may be received through apertures 222 and brought into threaded engagement with the apertures 196.

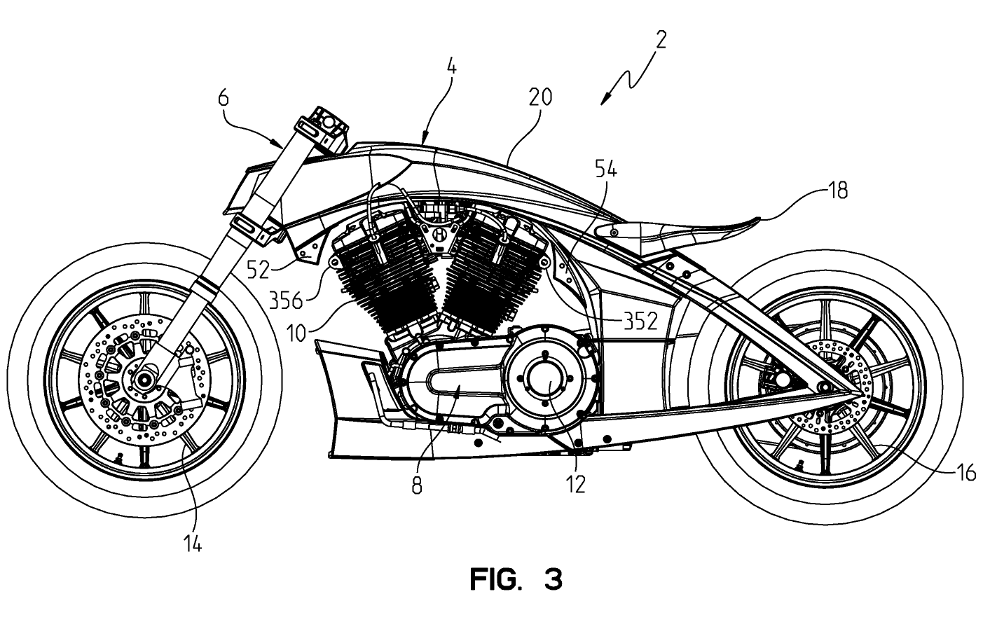

With reference now to FIGS. 3 and 23, power train 8 may now be brought into position against battery box 22 and upper main frame portion 20 whereby cap screws (not shown) may be positioned through counterbores 184 (FIG. 12) and brought into threaded engagement within threaded apertures in bosses 354 (FIG. 23). As shown in both FIGS. 3 and 23, engine 10 includes integrated flanges 352, 356 which may be connected to engine mounting sections 52 and 54 via clamps (not shown). As shown in FIG. 23, engine 10 also includes an air intake system 360 and it should be appreciated that a seal and throttle bodies may be positioned against air intake opening 74 (FIG. 22) to receive incoming air from the integrated air tank. The connection of the engine to the upper main frame portion 20 and the connection of the throttle bodies to the integrated air tank is shown in greater detail in our U.S. Patent Application Publication No. 2008/0190683, the subject of which is incorporated herein by reference.

At the same time, fasteners 410 (FIG. 23) may be received through apertures 226 of hard tails 26, 28 and be received within a threaded aperture of bosses 412 integral with power train 8. Chin fairing 24 may now be positioned with bosses 234 against integrated bosses 418 of power train 8 as shown in FIG. 23, and with lips 238 positioned within corresponding recesses 228 of hard tails 26, 28, whereupon fasteners 416 may be received through apertures 236 and into threaded engagement within a threaded aperture of bosses 418.

With respect to the attachment of the wheels and tires, as mentioned above, steering post 244 is received through lower triple clamp 242 into post receiving area 50 within the upper main frame portion 20 and through upper triple clamp 240, as best shown in FIG. 22. Bearings 450 would be positioned within respective recesses 110, 112 (see FIG. 11) and a threaded collar 452 maintains post 244 in position. As also mentioned above with respect to FIGS. 17 and 18, forks 300 are maintained within apertures 250 by way of fasteners 255 within apertures 254a, 254b and fasteners 275 within apertures 276a, 276b. A handlebar (not shown) may also be positioned between upper triple clamp 240 and upper cap 246 whereby fasteners 294 may maintain upper cap 246 in clamped retention against the handlebar. As for a rear tire and wheel, the hard tails 26, 28, as shown in FIG. 23 and as connected to battery box 22 and upper main frame portion 20, are shown bosses 210 and apertures 212 in position to receive an axle therethrough.

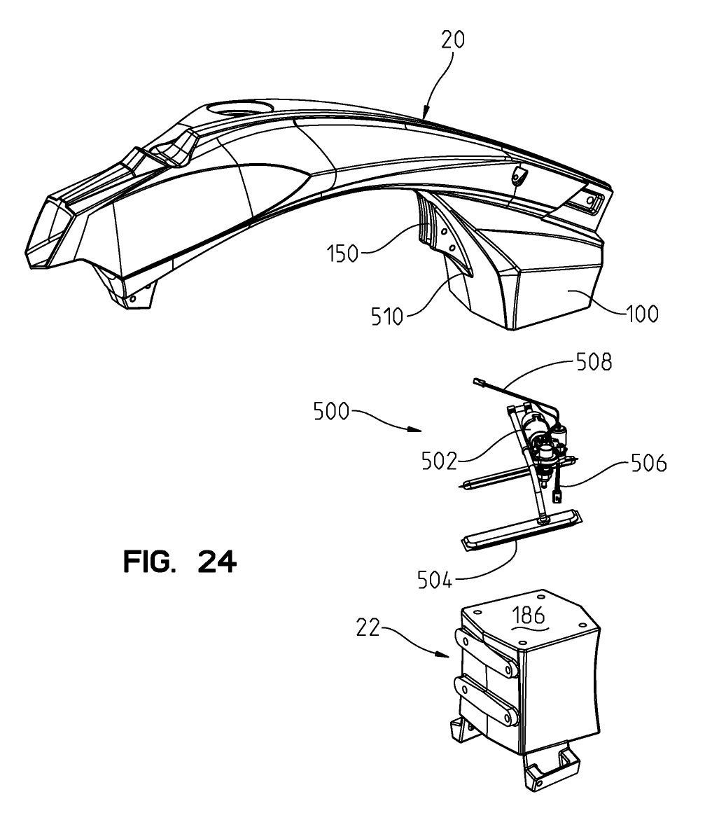

With respect to the electronics, FIG. 24 depicts an electronic submersible fuel pump 500 which may be positioned within enlarged tank portion 100. Pump 500 would include motor 502, fuel pickup 504, input power cable 504 and input signal cable 508. The pump 500 would be inserted into the opening at the bottom of the enlarged tank portion 100, and then sealed by a plug and retaining ring (not shown). A vent line, water drain line and a fuel rail are routed through portion 62 and through top area 172 of battery box.

Input signal cable 508 would extend outwardly through enlarged tank 100 at a position adjacent to position 510, such that control cable (not shown) could be dressed into the groove 150, and extend to a control panel (not shown) adjacent to a front of the motorcycle. At the same time, the input power cable 506 would extend through a sealed fitting (not shown) through the upper surface 186 of battery box 22. It should be appreciated that all of the cabling and/or wire harnesses could be run through the groove 150, and could also run through the air box to and from the front end of the motorcycle. The battery box 22 would house a battery (not shown) which powers the electronics of the motorcycle.

Once the electronics are completed, a rear access panel 520 (FIGS. 5, 22, 23) could enclose the battery box 22, via fasteners 522 received in threaded apertures 198 (FIG. 13). As shown best in FIG. 4, the rear face 160 of the upper main frame portion, and the access panel 520 form a complementary arcuate surface spaced for receiving a tire and wheel.

The seat 18 is also installed to the upper main frame portion 20. Seat 18 includes seat portions 530 which straddle the upper main frame portion at boss 140 (FIG. 7) where fasteners 532 may be received in threaded apertures 142.

It should be appreciated from the foregoing, that the provision of an upper main frame portion having an integrated air box and integrated fuel tank simplifies the manufacturing of the motorcycle, as well as provides an entirely new look. The position of the fuel tank also lowers the center of gravity as discussed above, and allows for a clean look for the electronic cabling.

Moreover, the provision of an upper main frame portion as discussed herein could be used for a platform of vehicles or for multiple platforms, for example, cruisers or touring motorcycles, with the provision of further multiple optional components, alternate battery boxes, rear wheel frame component with shock absorption systems etc.

What is claimed is:

1. A motorcycle comprising:
front and rear tires;
an engine; and
a frame comprising plural cast components coupled together, and encompassing the engine from at least the top and bottom thereof.

2. The motorcycle of claim 1, wherein the frame comprises an upper main frame portion extending from a position adjacent to the front tire, to a position adjacent the rear tire.

3. The motorcycle of claim 1, wherein the upper main frame portion has an integrated air tank and an integrated gas tank therein.

4. The motorcycle of claim 2, wherein the frame further comprises a lower rear frame portion attached to upper main frame portion adjacent to the rear tire.

5. The motorcycle of claim 4, wherein the frame further comprises a lower frame portion attached to the lower rear frame portion and extends to a position adjacent the front tire.

6. The motorcycle of claim 5, wherein the upper main frame portion, the lower rear frame portion and the lower frame portion comprise mounting sections for attachment to the engine.

7. The motorcycle of claim 4, wherein a lower face of the upper main frame portion and an upper face of the lower rear frame portion are substantially planar for attachment.

8. The motorcycle of claim 7, wherein a rear face of the upper main frame portion and a rear face of the lower rear frame portion form a complementary arcuate surface, spaced from the rear tire.

9. The motorcycle of claim 7, wherein the lower rear frame portion comprises a box-shaped portion, where the upper face of the lower rear frame portion is defined by a top wall of the box-shaped member.

10. The motorcycle of claim 9, wherein the box-shaped portion defines a battery box.

11. The motorcycle of claim 10, wherein a rear face of the battery box includes a cover.

12. A motorcycle comprising:
front and rear tires;
an engine; and
an upper one-piece frame portion having an integrated air tank and an integrated fuel tank therein.

13. The motorcycle of claim 12, wherein the integrated air tank occupies a generally forward portion of the upper frame portion and the integrated fuel tank occupies a generally rearward portion of the upper frame portion.

14. The motorcycle of claim 13, wherein the upper frame portion is cast aluminum.

15. The motorcycle of claim 14, wherein an integrated mid-wall within the upper frame portion separates the integrated fuel tank and integrated air tank.

16. The motorcycle of claim 15, wherein the internal volume of the cast aluminum fuel tank and mid-wall are coated with a polymeric material.

17. The motorcycle of claim 13, wherein a leading end of the upper frame portion is open and defines an air intake into the integrated air tank.

18. The motorcycle of claim 13, wherein the upper frame portion extends from a position adjacent to the front tire, to a position adjacent the rear tire.

19. The motorcycle of claim 18, wherein the frame further comprises a lower rear frame portion attached to upper main frame portion adjacent to the rear tire.

20. The motorcycle of claim 19, wherein the frame further comprises a lower frame portion attached to the lower rear frame portion and extends to a position adjacent the front tire.

21. The motorcycle of claim 20, wherein the upper frame portion, the lower rear frame portion and the lower frame portion comprise mounting sections for attachment to the engine.

22. The motorcycle of claim 21, wherein a lower face of the upper main frame portion and an upper face of the lower rear frame portion are substantially planar for attachment.

23. The motorcycle of claim 22, wherein the lower rear frame portion comprises a box-shaped portion, where the upper face of the lower rear frame portion is defined by a top wall of the box-shaped member.

24. The motorcycle of claim 23, wherein the box-shaped portion defines a battery box.

25. A motorcycle, comprising:
a frame comprising an upper main frame portion;
an integrated air tank defined by a forward portion of said upper main frame portion, where a forward open face of the integrated air tank defines an air intake;
upper and lower steering post sockets integrated into the frame, rearward of the air intake;
a steering post extending through the air intake portion of the frame and positioned in the steering post sockets; and
a steering clamp assembly.

26. The motorcycle of claim 25, wherein the steering clamp assembly comprises:
an upper clamp member having a center aperture for receiving the steering post, and apertures on either side of said center aperture for receiving forks;
a lower clamp member having a center aperture for receiving the steering post, and apertures on either side of said center aperture for receiving forks; and
a top cap receivable over said upper clamp member, said upper clamp member and said top cap being profiled for receiving a handle bar therethrough.

27. A front steering mechanism for a motorcycle, comprising:
an upper clamp member having a center aperture for receiving a steering post, and apertures on either side of said center aperture for receiving forks;
a lower clamp member having a center aperture for receiving the steering post, and apertures on either side of said center aperture for receiving forks;
a top cap receivable over said upper clamp member, said upper clamp member and said top cap being profiled for receiving a handle bar therethrough.
